(19) United States
(12) Patent Application Publication
(10) Pub. No.: US 2026/0203232 A1
(43) Pub. Date: Jul. 16, 2026

(54) PATTERN-BASED CACHE EVICTION

(71) Applicant: Dell Products L.P., Round Rock, TX (US)

(72) Inventors: Arieh Don, Newton (MA); Krishna Deepak Nuthakki, Bangalore (IN); Ramesh Doddaiah, Westborough, MA (US)

(73) Assignee: Dell Products L.P., Round Rock, TX (US)

(21) Appl. No.: 19/021,542

(22) Filed: Jan. 15, 2025

(51) Int. Cl. G06F 12/123; G06F 12/0891

(52) U.S. Cl. CPC G06F 12/123; G06F 12/0891

(57) ABSTRACT

A pattern-based cache eviction policy leverages I/O access patterns to optimize cache retention for data with predictable read-after-write behavior. The system generates and relies on pattern recognition and predictive analytics to identify the probability and timing of read operations following write operations on the same data blocks. The system enables retention of specific data in cache longer when a read operation is anticipated and evicts specific data when a read operation is not anticipated. A collection of I/O operations is received and analyzed for one or more access patterns. A predictive model is generated based on the one or more access patterns and is configured to forecast a future I/O operation. An I/O operation is input to the predictive model to determine an eviction event.

### BACKGROUND

In enterprise storage systems, caching plays a crucial role in optimizing latency for both read and write Input/Output (I/O) operations. Conventional cache eviction methods, such as Least Recently Used (LRU) or Most Frequently Used (MFU), effectively manage cache space by prioritizing data that is either accessed frequently or recently. However, these traditional algorithms overlook patterns in data access that lead to unnecessary cache evictions (i.e., removing data from cache to make room for new data). In particular, when data is written and subsequently read after a varying interval, these algorithms prematurely evict cached data, resulting in costly reloads from disk and increased latency.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one aspect, a method may include receiving a collection of I/O operations and analyzing the collection of I/O operations for one or more access patterns. A predictive model may be generated based on the one or more access patterns. The predictive model may be configured to forecast a future I/O operation. An I/O operation may be input to the predictive model to determine an eviction event.

According to another aspect, a system may include a memory and at least one processor that is operatively coupled to the memory. The at least one processor may be configured to perform the operations of receiving a collection of I/O operations and analyzing the collection of I/O operations for one or more access patterns. A predictive model may be generated based on the one or more access patterns. The predictive model may be configured to forecast a future I/O operation. An I/O operation may be input to the predictive model to determine an eviction event.

According to another aspect, a non-transitory machine-readable medium may store instructions that when executed by one or more processors cause the one or more processors to perform the operations of receiving a collection of I/O operations and analyzing the collection of I/O operations for one or more access patterns. A predictive model may be generated based on the one or more access patterns. The predictive model may be configured to forecast a future I/O operation. An I/O operation may be input to the predictive model to determine an eviction event.

The method, system, and non-transitory machine-readable medium may, alone or in combination include one or more of the following features. The predictive model may be a time-series forecasting model. The time-series forecasting model may be an autoregressive integrated moving average (ARIMA) model. Inputting the I/O operation to predictive model may include writing a data block to cache to generate a forecasted interval for a future read operation. The one or more access patterns may include a read-after-write pattern. The one or more access patterns may be based on a contiguous sequence of data. The future I/O operation may include a probability and a timing of a future read-after-write pattern. The eviction event may include retaining a data block in cache. The future I/O operation may include a high probability of a read occurring within a specified time window. The eviction event may include marking a data block for eviction. The eviction event may comprise one of a LRU operation, a MFU operation or a tag-based eviction operation.

### BRIEF DESCRIPTION OF THE DRAWINGS

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1A is a diagram of an example of a storage system, according to one or more aspects of the present disclosure;

FIG. 1B is a diagram of an example of a storage processor, according to one or more aspects of the present disclosure;

FIG. 2 is a diagram showing an example cache manager used to generate an adaptive eviction policy, according to one or more aspects of the present disclosure;

FIG. 3 is a flow diagram of a method of generating an adaptive cache eviction policy, according to one or more aspects of the present disclosure; and

FIG. 4 is a diagram of an example of a computing device, according to aspects of the disclosure.

### DETAILED DESCRIPTION

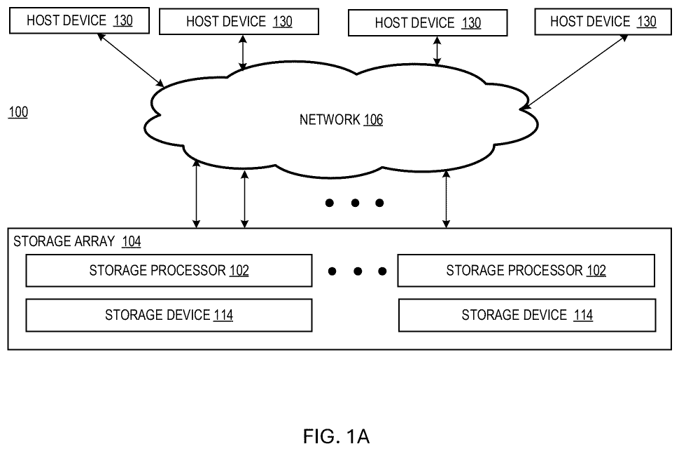

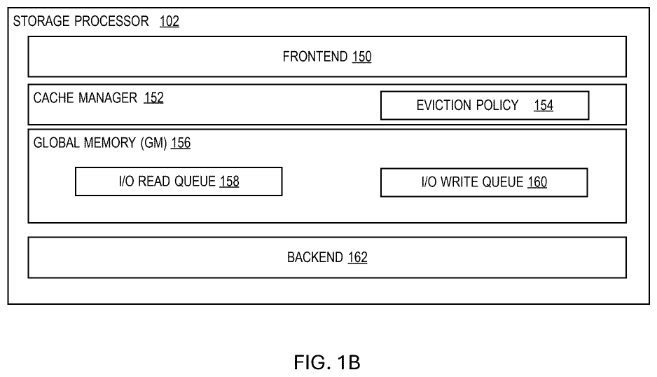

FIG. 1A is a diagram of an example of a storage system 100, according to aspects of the disclosure. As illustrated, the system 100 may include a storage array 104, a communications network 106, and a plurality of host devices 130. The communications network 106 may include one or more of a fibre channel (FC) network, the Internet, a local area network (LAN), a wide area network (WAN), and/or any other suitable type of network. The storage array 104 may include a storage system, such as DELL/EMC Powermax™, DELL PowerStore™, and/or any other suitable type of storage system. Each of the storage processors 102 may be configured to receive I/O requests from host devices 130 and execute the received I/O requests by reading and/or writing data to storage devices 114. Each of the host devices 130 may include a desktop computer, a laptop, a smartphone, an internet-of-things (IOT) device, and/or any other suitable type of computing device.

According to one aspect, each of storage devices 114 may be a non-volatile memory express (NVMe) drive. In another aspect, the storage devices may be solid-state drives (SSD). In some implementations, each of the storage devices 114 may be connected to the storage processors 102 via a Peripheral Component Interconnect Express (PCIe) connection. Each of the storage devices 114 may include a respective controller (not shown) and storage medium (not shown). The controller of each storage device 114 may include processing circuitry that is configured to perform various tasks, such as the retrieval and storage of data on the medium, wear leveling, error handling, garbage collection, as well as other functions. The medium may include an array of NAND memory cells and/or any other suitable type of storage medium.

In some implementations, any of the storage devices 114 may be internal to one of the storage processors 102 and coupled to the storage processor via an M.2 slot that is provided on the motherboard of that storage processor. Additionally, or alternatively, in some implementations, any of the storage devices 114 may be part of a disk array enclosure (DAE) and coupled to each of the storage processors 102 via a respective InfiniBand adapter of that storage processor. It will be understood that the present disclosure is not limited to any specific method for connecting storage devices 114 to storage processors 102.

In some implementations, the storage processors 102 and the storage devices 114 may be located in geographically disparate locations. For example, the storage processors 102 may be distributed across multiple cities, countries, or continents. Similarly, the storage devices 114 (and/or the disk array enclosures of which they are part) may also be distributed across multiple cities, countries, or continents. Additionally or alternatively, in some implementations, the storage processors 102 and the storage devices 114 may be located in the same geographic location, but in different buildings of the same campus (or different rooms of a large building). As discussed further below, the storage array 104 may employ a method for reading and writing I/O requests and other data across remote locations of the storage devices 114 and/or storage processors 102.

FIG. 1B is a diagram illustrating aspects of the operation of the storage processor 102, according to aspects of the disclosure. FIG. 1B illustrates that the storage processors 102 may together implement a frontend 150, a backend 162, and a global memory (GM) 156. GM 156 may include a memory space that is shared among the storage processors in storage array 104, and which is used for the caching of data. GM 156 may be formed by pooling into the same address space the memories of storage processors 102. According to one aspect, GM 156 may be implemented by using a plurality of Dynamic Random Access Memory (DRAM) modules configured to temporarily store I/O requests in one or more queues or stacks, including an I/O read queue 158 and an I/O write queue 160.

Each of the frontend 150 and backend 162 may be implemented as one or more processes that are executed on the storage processors 102. The frontend 150 may be responsible for caching in GM 156 data associated with incoming write requests and the backend 162 may be responsible for destaging the data from GM 156 into the storage devices 114. In addition, the backend 162 may be responsible for loading, into the GM 156, data associated with incoming read requests, and the frontend 150 may be responsible for returning the cached data to the senders of the read requests. The frontend 150 and backend 162 may be implemented as various services (or kernel components) of the storage processors 102.

A cache manager 144 may be configured to implement caching of data into the GM 156, or as described below, managing cache eviction operations when local GM 156 is, for example, full, exceeds a predefined memory utilization threshold, or meets certain conditions according to an eviction policy. While the cache manager 152 is depicted as a discrete block, it will be understood that, in some implementations, cache manager 152 may be integrated into the frontend 150 and/or the backend 162. As described herein, the cache manager 152 may be configured to select a memory location for storage, retention and eviction of data associated with incoming I/O operations.

The cache storage, retention and eviction may be performed based on an eviction policy 154. The eviction policy 154 may be implemented by using one or more of: (i) processor-executable instructions, (ii) logical expressions, (iii) configuration settings, and/or in any other suitable manner. The eviction policy 154 may specify one or more rules or conditions for selecting a cache location, as well as retaining or evicting data in those locations. In some implementations, at least one of the rules and conditions that comprise the eviction policy 154 may be based on the current utilization of GM 142, including the time-based characteristics of read and write operations in the I/O read queue 146 and/or the I/O write queue 148.

According to one aspect, the eviction policy 154 may leverage I/O access patterns to optimize cache retention, particularly for data with predictable read-after-write behavior. According to one aspect the cache manager 152 and the eviction policy 154 may generate and rely on pattern recognition and predictive analytics to identify the probability and timing of read operations following write operations on the same data blocks. By doing so, the eviction policy 154 may enable the cache management system to retain specific data in cache longer when a read operation is anticipated. Accordingly, aspects of the present disclosure provide a practical solution to storage and memory access procedures by improving read I/O latency and reducing overall system workload.

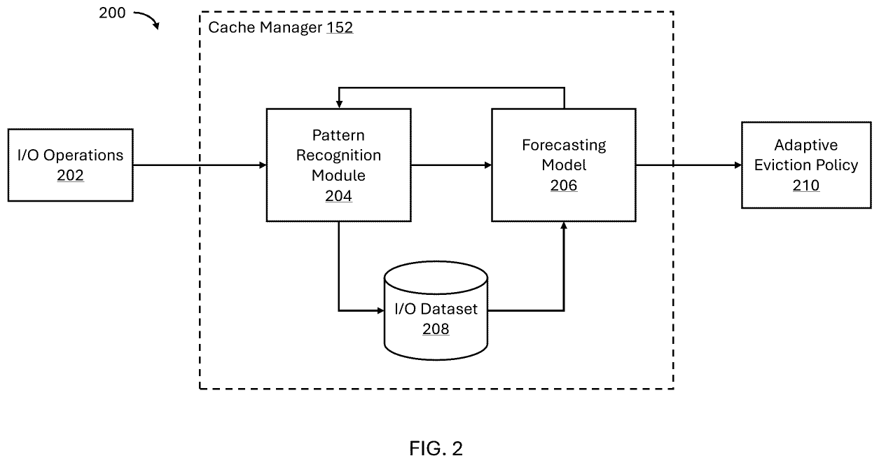

FIG. 2 is a diagram of a topology 200 with an example cache manager 152 used to generate an adaptive eviction policy, according to one or more aspects of the present disclosure. I/O operations 202, including read and write requests, may be received from a host, such as a host 130 shown in FIG. 1A. The I/O operations 202 may include requests from one or more applications or services running on the host. The cache manager 152 may include a pattern recognition module 204. I/O operations from one or more host applications may be received and analyzed for access patterns.

According to one aspect, each application may exhibit unique access patterns in which write operations may be followed by read operations on the same data block. The interval between these operations may vary based on application workload characteristics. The pattern recognition module 204 may collect and analyze these intervals to identify access patterns. The pattern recognition module 204, may for example, track both the frequency and timing of read-after-write events (e.g., a write operation on a given memory block followed by a read operation on that same block). The cache manager 152 and the pattern recognition module may continuously monitor and track incoming I/O requests. By continuously monitoring I/O operations and characteristics, the cache manager 152 may build a dataset 208 that reflects these read-after-write access patterns over time, helping it distinguish between data likely to be accessed again in a short period of time, and data that may be evicted because it may not be used for a longer period of time.

According to one aspect, a forecasting model 206 may be included to predict a likelihood of future I/O operations and their potential characteristics. For example, a future I/O operation may include a read-after-write operation on a data block in cache memory. To accurately forecast when a read operation may follow a write, the forecasting model may include an autoregressive integrated moving average (ARIMA) model. As a time series forecasting algorithm, an ARIMA model may be well-suited for capturing temporal patterns and predicting future events based on historical data.

In operation, according to one aspect, for each extent (e.g., a contiguous sequence of data chunks), the ARIMA model may consider the observed read-after-write intervals, building a predictive model capable of forecasting the probability and timing of future reads after writes. Using this forecasting model the cache manager 152 may dynamically and efficiently assess which cached data blocks are likely to be read soon and should therefore be retained in the cache. According to one aspect, the forecasting results may be generated and embodied in an adaptive eviction policy 210. According to one aspect, since data access patterns do not change often, the cache manager 152 running the ARIMA model can do so at a lower processing rate which may prolong the training time but also may ensure not to consume too many computational resources of the system. According to one aspect, a storage array, such as storage array 104 of FIG. 1A, may be equipped with dedicated hardware to run such models.

The cache manager 152 through the pattern recognition module 204 and the forecasting module 206 may provide enhanced cache retention using adaptive eviction logic. According to one aspect, instead of using static eviction criteria, the cache manager 152 may employ the adaptive eviction policy 210, where cache retention decisions may be influenced by the ARIMA-based forecasts of the forecasting model 206.

For example, when a data block is written to the cache, the cache manager 152 may check the forecasted interval for a potential read operation. If the forecast indicates a high probability of a read operation occurring on that block within a specified time window, the manager may retain the block in the cache. Conversely, if the forecasting model suggests that a read operation is unlikely to follow within a period of time, the cache manager 152 may mark the block for eviction based on traditional eviction procedures, such as without limitation, a least recently used (LRU) procedure, a most frequently used (MFU), or a tag-based principle, including an indication that the block may be cleared sooner if needed. This adaptive approach allows the cache manager 152 to prioritize cache space for data with a high probability of near-term read operations, reducing unnecessary evictions and avoiding costly data reloads.

While some eviction procedures are detailed herein, one of skill in the art will recognize that other eviction procedures may be implemented without deviating from the scope of the present disclosure and the eviction procedures are not limited to only those names here.

According to one aspect, the cache manager 152 and the adaptive eviction policy may provide efficient use of cache resources with extent-level forecasting. For example, the cache manager may operate at the extent level, meaning it may track and forecast read-after-write intervals for groups of data blocks (e.g., tracks) rather than individual cache data extents (e.g., slots). Such granularity in tracking and forecasting may enable the system to manage cache resources more efficiently, reducing overhead and enhancing scalability. Further, by maintaining read-after-write statistics at the extent level, the system may better predict access patterns for larger data segments. This may be particularly useful in high-throughput environments where tracking individual I/Os would be impractical. Additionally, extent-level forecasting also facilitates the grouping of cache data extents based on similar access patterns, allowing the system to optimize eviction decisions for clusters of data with shared I/O characteristics.

The cache manager 152 and the implementation of an adaptive eviction policy 210 also provide performance benefits and latency reduction in I/O operations. For example, by minimizing unnecessary cache evictions, the cache manager may ensure that data remains readily available in cache for anticipated read operations, thus significantly reducing read I/O latency. This use of the adaptive eviction policy 210 may also reduce disk and fabric bandwidth consumption by avoiding frequent data retrievals from slower storage tiers, leading to improved overall system performance. Additionally, implementation of the adaptive eviction policy may reduce CPU utilization associated with cache management tasks, as the cache manager 152 may avoid repeated cycles of data loading and eviction, thus optimizing computational resources for other critical tasks.

According to one aspect, the cache manager 152 may include an adaptive feedback loop for continuous improvement. For example, the cache manager 152 may periodically update the ARIMA model based on observed and continuing I/O behavior. This allows the manager and forecasting model 206 to continuously refine the forecasts as access patterns evolve over time. Further, by integrating real-time feedback, the system can adjust the adaptive eviction policy 210 to account for changing workloads, ensuring that cache resources are used effectively even as data access patterns shift. Further, the feedback mechanism not only enhances the accuracy of the predictive model but also may ensure long-term scalability and adaptability to diverse application environments.

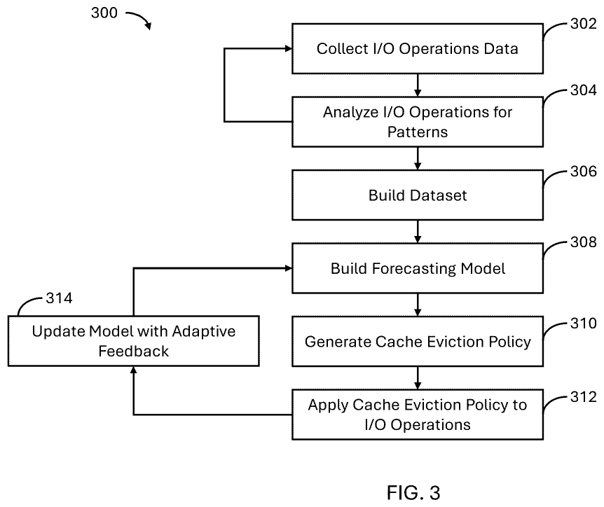

FIG. 3 is a flow diagram depicting a method 300 of generating an adaptive cache eviction policy, according to one or more aspects of the present disclosure. As described herein, a storage system, device, array or processor may include a cache management system or manager that may direct the reading and writing requests of incoming I/O operations in cache memory according to an adaptive eviction policy. According to one aspect, as shown in block 302, a system may collect I/O operations data. The data may include, for example, write operation characteristics, read operation characteristics, intervals and/or timing information between write and read operations, and the like. The data collected may be on a per application basis and reflect intervals between write and read operations that may vary based on the application workload characteristics.

As shown in block 304, the collected I/O operations data for each application may be analyzed for patterns. For example, the intervals between write and read operations may be analyzed to identify access patterns that track both the frequency and the timing of read-after-write events. According to one aspect, the collection and analysis of I/O operations data may be continuous to build a robust dataset reflecting ongoing read-after-write access patterns. The continual updating of the dataset may help distinguish between data that is likely to be quickly accessed and data that may be evicted because it may not be accessed for a long period of time.

From the analysis of the I/O Operations and identification of access patterns a dataset may be built, shown in block 306. Using the dataset, as shown in block 308, a forecasting model may be built. According to one aspect, the forecasting model may be an ARIMA time series forecasting model. ARIMA models may be well-suited for capturing temporal patterns and predicting future events based on the historical I/O operations data in the dataset. According to one aspect, for each extent in the cache memory, the ARIMA model may be built using the historical I/O operational data to generate probability and timing of future reads following writes. Accordingly, the system may dynamically assess which cached data blocks are likely to be read and when they may be read.

From the forecasting model a cache eviction policy may be generated, shown in block 310. The eviction policy may include rules and conditions upon which the cache may be processed, including retaining data and evicting data. In operation, shown in block 312, for example, the eviction policy may be generated according to forecasted intervals for a potential read operation such that upon receiving a write operation, the forecasted interval until the written data will be read may determine if the data is retained or evicted. If the forecast indicates a high probability of a read operation occurring within a specified time window, the system may retain the block in the cache. If, however, the forecast indicates that a read is unlikely to follow soon, the system may mark the block for eviction based on traditional eviction procedures, including LRU, MFU, and the like.

As shown in block 314, an adaptive feedback loop may periodically update the ARIMA model based on observed I/O behavior to allow the system to continuously refine its forecasts as access patterns evolve over time. Integrating real-time feedback allows the system to adjust its cache eviction strategy to account for changing workloads, ensuring that cache resources are used effectively even as data access patterns shift. The adaptive feedback and updating of the ARIMA model not only enhance the accuracy of the predictive model but also ensures long-term scalability and adaptability to diverse application environments.

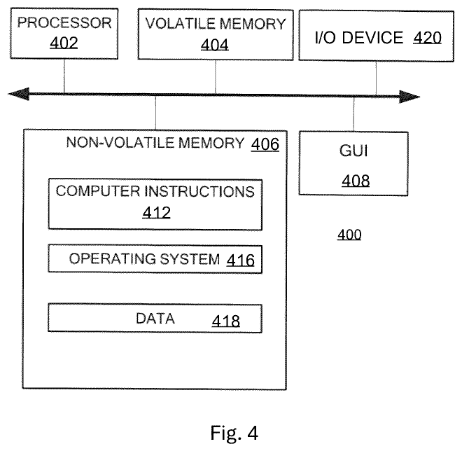

Referring to FIG. 4, in some embodiments, a computing device 400 may include processor 402, volatile memory 404 (e.g., RAM), non-volatile memory 406 (e.g., a hard disk drive, a solid-state drive such as a flash drive, a hybrid magnetic and solid-state drive, etc.), graphical user interface (GUI) 408 (e.g., a touchscreen, a display, and so forth) and input/output (I/O) device 420 (e.g., a mouse, a keyboard, etc.). Non-volatile memory 406 stores computer instructions 412, an operating system 416 and data 418 such that, for example, the computer instructions 412 are executed by the processor 402 out of volatile memory 404. Program code may be applied to data entered using an input device of GUI 408 or received from I/O device 420.

Described herein are concepts, techniques and structures for pattern-based cache eviction based on predicted read-after-write intervals. The systems and managers described herein provide a strategic enhancement to traditional cache management techniques by leveraging predictive analytics to optimize cache retention. By recognizing and forecasting read-after-write intervals, the concepts, techniques and structures described herein enable the storage system to make informed eviction decisions, reducing latency for read operations and improving overall performance. This approach is particularly valuable in enterprise storage environments with applications that exhibit predictable access patterns, as it aligns cache resources with I/O demands, maximizing efficiency and minimizing wasteful evictions.

In some aspects or embodiments, the term “I/O request,” “I/O operation” or simply “I/O” may be used to refer to an input or output request. In some embodiments, an I/O request may refer to a data read or write request.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used throughout the disclosure, the term “vector” refers to a sequence of numbers (and/or other elements). The phrase “the element having index i” refer to the i-th element in the sequence. For example, if i=1, the phrase i-th element in the sequence would refer to the first element in the sequence, if i=2, the phrase i-th element in the sequence would refer to the second element in the sequence, and so forth.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method comprising:
receiving a collection of input/output (I/O) operations;
analyzing the collection of I/O operations for one or more access patterns;
generating a predictive model based on the one or more access patterns, the predictive model configured to forecast a future I/O operation; and
in response to writing a data block to a cache, inputting write-operation information for the data block to the predictive model to determine, based on a forecasted read-after-write interval for the data block, an eviction event for the data block, wherein the eviction event controls retention of the data block in the cache.

2. The method of claim 1 wherein the predictive model is a time-series forecasting model.

3. The method of claim 2 wherein the time-series forecasting model is an autoregressive integrated moving average (ARIMA) model.

4. The method of claim 1, wherein inputting the I/O operation to predictive model includes writing a data block to cache to generate a forecasted interval for a future read operation.

5. The method of claim 1 wherein the one or more access patterns include a read-after-write pattern.

6. The method of claim 1 wherein the one or more access patterns are based on a contiguous sequence of data.

7. The method of claim 1 wherein the future I/O operation includes a probability and a timing of a future read-after-write pattern.

8. The method of claim 1, wherein the eviction event includes retaining a data block in cache.

9. The method of claim 8 wherein the future I/O operation includes a probability of a read occurring within a specified time window.

10. The method of claim 1, wherein the eviction event includes marking a data block for eviction.

11. The method of claim 10 wherein the eviction event comprises one of a least recently used (LRU) operation, a most frequently used (MFU) operation or a tag-based eviction operation.

12. A system comprising:
a memory; and
at least one processor that is operatively coupled to the memory, the at least one processor being configured to perform the operations of:
receiving a collection of input/output (I/O) operations;
analyzing the collection of I/O operations for one or more access patterns;
generating a predictive model based on the one or more access patterns, the predictive model configured to forecast a future I/O operation; and
in response to writing a data block to a cache, inputting write-operation information for the data block to the predictive model to determine, based on a forecasted read-after-write interval for the data block, an eviction event for the data block, wherein the eviction event controls retention of the data block in the cache.

13. The system of claim 12 wherein the predictive model is an autoregressive integrated moving average (ARIMA) time-series forecasting model.

14. The system of claim 12, wherein inputting the I/O operation to predictive model includes writing a data block to cache to generate a forecasted interval for a future read operation.

15. The system of claim 12 wherein the one or more access patterns include a read-after-write pattern.

16. The system of claim 12 wherein the one or more access patterns are based on a contiguous sequence of data.

17. The system of claim 12 wherein the future I/O operation includes a probability and a timing of a future read-after-write pattern.

18. The system of claim 12, wherein the future I/O operation includes a probability of a read occurring within a specified time window and the eviction event includes retaining a data block in cache.

19. The system of claim 12, wherein the eviction event includes marking a data block for eviction using one of a least recently used (LRU) operation, a most frequently used (MFU) operation or a tag-based eviction operation.

20. A non-transitory computer-readable medium storing one or more processor-executable instructions, which when executed by at least one processor cause the at least one processor to perform the operations of:
receiving a collection of input/output (I/O) operations;
analyzing the collection of I/O operations for one or more access patterns;
generating a predictive model based on the one or more access patterns, the predictive model configured to forecast a future I/O operation; and
in response to writing a data block to a cache, inputting write-operation information for the data block to the predictive model to determine, based on a forecasted read-after-write interval for the data block, an eviction event for the data block, wherein the eviction event controls retention of the data block in the cache.
